(19) United States
(12) Patent Application Publication
(10) Pub. No.: US 2026/0245386 A1
(43) Pub. Date: Aug. 20, 2026

(54) AUTOMATIC IDENTIFICATION OF VEHICLE ATTRIBUTES

(71) Applicant: Carvana IPHC, LLC, Tempe, AZ (US)

(72) Inventors: Alan Melling, Tempe, AZ (US); Nathan Danielsen, Tempe, AZ (US); Ricky Hunter, Tempe, AZ (US); Spencer Murray, Tempe, AZ (US)

(73) Assignee: Carvana IPHC, LLC, Tempe, AZ (US)

(21) Appl. No.: 19/054,038

(22) Filed: Feb. 14, 2025

(51) Int. Cl. G06V 20/70; G06V 10/40; G06V 10/82; G08G 1/017

(52) U.S. Cl. CPC G06V 20/70; G06V 10/40; G06V 10/82; G08G 1/0175

(57) ABSTRACT

Systems and methods including one or more processors and one or more non-transitory storage devices storing computing instructions configured to run on the one or more processors and perform acts of identifying one or more attributes of a vehicle using a machine vision system based on at least one of a vehicle identifier, an array of one or more vehicle attributes, or an array of one or more images of the vehicle; adding one or more annotations to the one or more images of the vehicle based on the one or more attributes of the vehicle; and coordinating displaying at least one image of the one or more images of the vehicle, as annotated. Other embodiments are disclosed herein.

### TECHNICAL FIELD

This disclosure generally relates to identifying vehicle attributes, and more specifically, to machine vision systems that identify the vehicle attributes.

### BACKGROUND

Identifying vehicle attributes (e.g., features) is a critical task in a variety of applications. For example, autonomous driving, eCommerce, fleet management, and parking assistance systems can all use vehicle attribute identification systems. The features may include, for example, shape, size, color, headlights, license plates, transmission, drivetrain, engine type, trim, software package, and other vehicle details. The ability to accurately detect and classify car features is essential for enhancing safety, improving user experience, and enabling automated systems to interact seamlessly with vehicles.

Identifying these attributes presents numerous challenges, particularly in environments where conditions are variable or dynamic. For instance, lighting conditions, weather conditions, occlusions, and path around a vehicle (when taking a 360 degree capture) can significantly impact the ability of a system to accurately capture and analyze a vehicle's features. Further, shadows, reflections, and/or glare created by a capture environment may obscure critical details and make it difficult for some systems to identify vehicle attributes. In addition to environmental challenges, variations in vehicle designs and models can complicate the identification process. Vehicles come in a wide range of shapes, sizes, and colors, with numerous variations in exterior design elements (e.g., grills, bumpers, and trim). This diversity makes it difficult for systems to reliably distinguish one car from another, or to correctly identify specific features across different vehicles. Moreover, vehicle attribute identification systems often encounter issues of scalability and/or robustness. An increasing prevalence of autonomous vehicles and an expansion of the eCommerce marketplace for vehicles can create problems with large-scale deployments of vehicle attribute identification systems such as, for example, latency and errors. Current methods often require significant computational resources and may struggle to maintain performance across diverse and unpredictable real-world conditions.

In view of the above, there is a need for a new and useful system and/or method for vehicle attribute identification.

### SUMMARY

A number of embodiments can include a system. The system can include one or more processors and one or more non-transitory computer-readable storage devices. The one or more non-transitory computer-readable storage devices can store computing instructions. The computing instructions can be configured to communicate with the one or more processors and cause the one or more processors to perform identifying one or more attributes of a vehicle using a machine vision system based on at least one of a vehicle identifier, an array of one or more vehicle attributes, or an array of one or more images of the vehicle; adding one or more annotations to the one or more images of the vehicle based on the one or more attributes of the vehicle; and coordinating displaying at least one image of the one or more images of the vehicle, as annotated.

Various embodiments include a method. The method can be implemented via execution of computing instructions configured to run at one or more processors and/or configured to be stored at non-transitory computer-readable media The method can comprise identifying one or more attributes of a vehicle using a machine vision system based on at least one of a vehicle identifier, an array of one or more vehicle attributes, or an array of one or more images of the vehicle; adding one or more annotations to the one or more images of the vehicle based on the one or more attributes of the vehicle; and coordinating displaying at least one image of the one or more images of the vehicle, as annotated.

Various embodiments can include an article of manufacture. The article of manufacture can include a non-transitory, tangible computer readable storage medium. The non-transitory, tangible computer readable storage medium can store instructions that, in response to execution by a computer, cause the computer to perform operations comprising identifying one or more attributes of a vehicle using a machine vision system based on at least one of a vehicle identifier, an array of one or more vehicle attributes, or an array of one or more images of the vehicle; adding one or more annotations to the one or more images of the vehicle based on the one or more attributes of the vehicle; and coordinating displaying at least one image of the one or more images of the vehicle, as annotated.

### BRIEF DESCRIPTION OF THE DRAWINGS

To facilitate further description of the embodiments, the following drawings are provided in which:

FIG. 1 illustrates a flowchart for an exemplary method for vehicle attribute identification, according to various embodiments;

FIG. 2 illustrates a block diagram of an exemplary system for a computer network, according to various embodiments; and

FIG. 3 illustrates a block diagram of an exemplary computer system, according to various embodiments.

### DESCRIPTION OF EXAMPLES OF EMBODIMENTS

In various embodiments, the techniques described herein can provide a practical application and several technological improvements. In various embodiments, the techniques can provide for increased accuracy for machine vision systems in identifying vehicle attributes. These techniques can provide a significant improvement over conventional approaches of identifying vehicle attributes, such as ingesting unverified vehicle data from third parties.

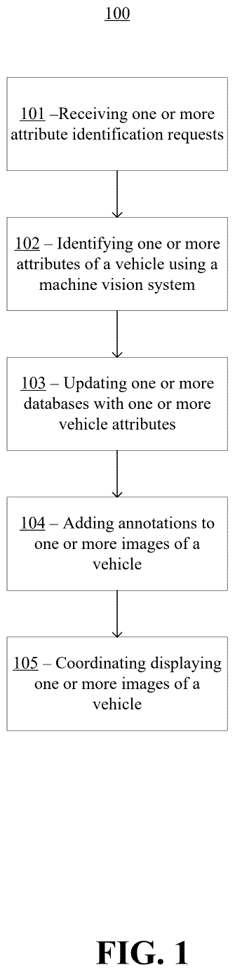

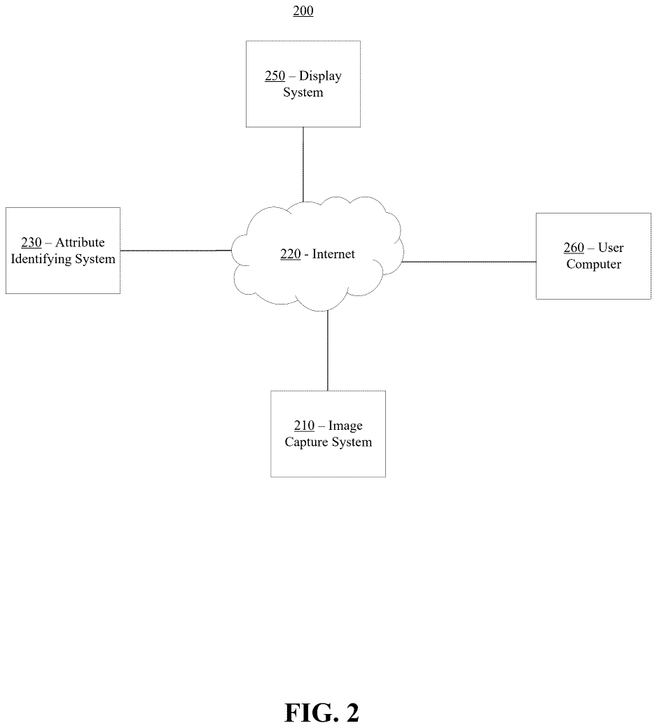

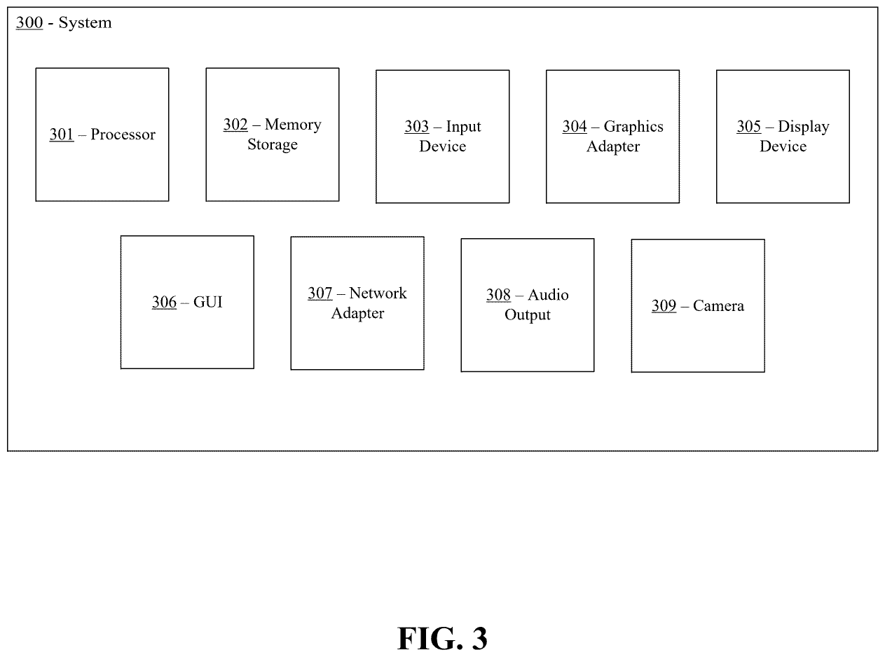

FIG. 1 illustrates a flow chart for a method 100, according to various embodiments. Method 100 is merely exemplary and is not limited to the embodiments presented herein. Method 100 can be employed in many different embodiments or examples not specifically depicted or described herein. In various embodiments, the activities of method 100 can be performed in the order presented. In other embodiments, the activities of method 100 can be performed in any suitable order. In still other embodiments, one or more of the activities of method 100 can be combined or skipped. In various embodiments, system 200 (FIG. 2) or system 300 (FIG. 3) can be suitable to perform method 100 and/or one or more of the activities of method 100. In these or other embodiments, one or more of the activities of method 100 can be implemented as one or more computer instructions configured to run at one or more processing modules and configured to be stored at one or more non-transitory memory storage modules. Such non-transitory memory storage modules can be part of a computer system such as image capture system 210 (FIG. 2), attribute identifying system 230 (FIG. 2), display system 250 (FIG. 2), and/or user computer 260 (FIG. 2). The processing module(s) can be similar or identical to the processing module(s) described above with respect to computer system 300 (FIG. 3).

In various embodiments, method 100 may comprise a step 101 of receiving one or more attribute identification requests. An attribute identification request can be received from a number of different sources. For example, a vehicle identification request can be received from image capture system 210 (FIG. 2), display system 250 (FIG. 2), and/or user computer 260 (FIG. 2). In various embodiments, all or a portion of an attribute identification request can be omitted and/or skipped. In various embodiments, attribute identifying system 230 (FIG. 2) can generate its own attribute identification request and/or all or a portion of method 100 can run automatically after images of a vehicle are captured and/or received. An attribute identification request can comprise a vehicle identifier, an array of images of a vehicle, and/or an array of vehicle attributes. A vehicle identifier can comprise a unique, alphanumeric sequence used to identify a vehicle. For example, a vehicle identifier can comprise a VIN, a tail number, a serial number, a hull identification number, and/or a bespoke sequence assigned to a vehicle. One or more images and/or links to one or more images in a file storage system (e.g., link to remote storage and/or a file path in local storage). The images can be static or dynamic images. Static images can be included as a default (e.g., images of an exterior of an automobile), while other images can be included only for certain vehicles (e.g., images of a charging port and/or cord for an electric vehicle). An array of vehicle attributes can be formatted as an ordered list of requested attributes (e.g., as JSON array and/or a JavaScript array). Some attributes can be included by default in an array due to their presence in most vehicles (e.g., vehicle color). In various embodiments, attributes in an array can be determined using a vehicle identifier and/or one or more images of a vehicle. For example, a year, make, and/or model encoded in a VIN can populate one or more attributes known to be present on the vehicle. The presence of one or more images either in an array and/or in storage can also be used to populate an attribute array. For example, images labeled as being of a charging port, third row seat, captain's chair, sunroof, and many other vehicle features can trigger the presence of those attributes in the array. In many embodiments, one or more images of a vehicle can comprise one or more images of an abstract representation of a vehicle. For example, 3D models, wireframes, voxel models, and other graphical representations of various attributes on a vehicle (e.g., charging port, 3D row seat, etc.) can be used.

Images of a vehicle (e.g., car, truck, motorcycle, boat, airplane, etc.) can be taken in a 3D scanner. For example, an EinScan SE Desktop 3D Scanner, an Afinia EinScan-Pro 2X PLUS Handheld 3D Scanner, and/or an EinScan-SE White Light Desktop 3D Scanner can be used. A 3D scanner can comprise a photography studio configured to create 3D displays. For example, U.S. Pat. No. 10,063,758 and application Ser. Nos. 18/331,605, 18/545,424, 18/544,930, 18/535,071, 18/430,231, 18/789,315, and 17/692,498, which are incorporated herein by this reference in their entirety, describe representative photography studios configured to capture images of a vehicle. In various embodiments, a 3D scanner can comprise a stage where a vehicle to be photographed is placed. The stage can be located in an interior chamber of a 3D scanner and/or can be placed in an approximate center of a 3D scanner. A stage can be configured to turn a vehicle while a camera captures images. A camera in a 3D scanner can be held in a fixed position or moved around a vehicle while images are captured. For example, a camera can be mounted on a robotic arm (or a rail) and moved around a vehicle. An interior chamber of a 3D scanner can be configured to project uniform, diffused lighting onto a stage. In this way, light reflected off of a vehicle can be minimized or completely eliminated by reducing or eliminating point sources of light.

One or more images can be taken in other capture environments that are not a 3D scanner. For example, one or more images can be taken outside or in a building using a handheld camera, a smartphone, a wearable electronic device, and/or some other portable electronic device outfitted with an image sensor and/or camera (e.g., user computer 260 (FIG. 2) and/or system 300 (FIG. 3)). In various embodiments, a human holding an electronic device can walk, run, and/or be transported around a vehicle while capturing images and/or video. In various embodiments, a 3D scanner can be a part of and/or controlled by image capture system 210 (FIG. 2). In various embodiments, an autonomous vehicle (AV) mounted camera can be used to capture images of a vehicle. An AV can be moved in an approximately circular or elliptical path around a vehicle. The AV can move a camera so that the camera focuses on the vehicle while the AV travels along the path around the vehicle. In various embodiments, an AV can repeat a path around a vehicle at multiple altitudes, heights, and/or depths to capture additional images. In other embodiments, an AV can be outfitted with multiple cameras at different altitudes, heights, and/or depths to capture the additional images. Images of an automobile can be taken in a 3D capture environment other than a 3D scanner. For example, images can be taken outdoors (e.g., in a parking lot), in a building (e.g., a storeroom or showroom), under a shade covering (e.g., veranda or tent), or in any other environment configured for image capture.

One or more images can be taken radially around (e.g., around a central axis) of a vehicle. In this way, the one or more images can be taken of the vehicle from multiple angles and/or views, thereby giving a 360 degree view around the vehicle when combined. When a 3D scanner is used, various functions can be used to obtain radially captured images. For example, one or more cameras can be mounted to an approximately circular rail along the circumference of an interior chamber, and these cameras can then be moved around the object while taking photographs. As another example, a stage of a 3D scanner can be configured to rotate while one or more cameras mounted at fixed positions take photographs. One or more cameras in a 3D scanner can be set at multiple levels to capture varied angles of a vehicle at different altitudes, heights, and/or depths. For example, a first camera can be placed on a floor, a second camera can be placed above a vehicle (e.g., directly above and/or angled down at the vehicle), and a third can be placed between the first and the second cameras. In embodiments where a portable electronic device is used to take the one or more images, the portable electronic device and/or a user operating the portable electronic device can be instructed by a software application stored on the portable electronic device to move around an object while taking pictures.

In various embodiments, method 100 can comprise a step 102 of identifying one or more attributes. One or more different vehicle attributes can be identified in activity 102. For example, a vehicle year, a vehicle make, a vehicle model, a vehicle transmission type, a vehicle engine type, a vehicle color, a vehicle trim package, and/or a vehicle software package can be identified. In various embodiments, existing attributes of a vehicle can be pulled from a vehicle information database when identifying a vehicle attribute. For example, a unique identifier for a vehicle (if one is known) can be used as a key value to pull the existing vehicle information from the database. As another example, vehicle information about a plurality of vehicles can be pulled to determine a universe of possible attributes for identification. For example, vehicle information from a plurality of vehicles can be used to generate textual descriptions of a universe of trim packages for a specific type of vehicle. The vehicle information can be generated by using or more language models to decipher a VIN and then generate a textual description of the vehicle and/or the attribute. For example, natural language describing the attribute and/or marketing copy featuring the attribute can be generated. In various embodiments, one or more images of a vehicle can be used to identify attributes of a vehicle. For example, images of a vehicle from multiple angles and/or perspectives can be analyzed by a computer vision system to identify an attribute. As a more specific example, exterior images taken from a high vantage point and/or images of an interior of a vehicle comprising a roof can be used to identify whether a sunroof is present.

In various embodiments, a machine vision system can comprise a machine learning algorithm. A machine learning algorithm can be understood as a set of software based rules designed to learn from and make decisions based on patterns in a dataset without being explicitly programmed for making the decisions. For example, a machine learning algorithm can decide what attributes are shown in an image (e.g., a year, make, model, trim, etc.). In various embodiments, a pre-trained machine learning algorithm can be used, and the pre-trained algorithm can be re-trained on training data. For example, images of vehicles labeled with their associated attributes and/or accompanied by a textual description of the attribute can be used as training data. In some embodiments, an abstract representation of a vehicle can be used to train a machine learning algorithm. Abstract representations can comprise salient aspects of an attribute, thereby making it easier for the trained machine learning to pattern match against novel imagery of that attribute. In this way, signals favoring attributes of specific vehicle types and/or models can be attenuated. In various embodiments, a machine learning algorithm can also consider both historical and dynamic input of vehicles and their associated attributes. In this way, a machine learning algorithm can be trained iteratively as new vehicles are received at a vehicle information database. In various embodiments, a machine learning algorithm can be trained, at least in part, on a single vehicle or the single vehicle can be weighted in a training data set. In this way, a machine learning algorithm tailored to a specific vehicle can be generated. In the same or different embodiments, a machine learning algorithm tailored to a single vehicle can be used as a pre-trained algorithm for a similar vehicle (e.g., vehicles with similar attributes). In several embodiments, due to a large amount of data needed to create and maintain a training data set, a machine learning model can use extensive data inputs to generate a list of attributes. Due to these extensive data inputs, In various embodiments, creating, training, and/or using a machine learning algorithm configured to generate a customized GUI cannot practically be performed in a mind of a human being.

A machine learning algorithm can comprise a large language model (LLM). A LLM can comprise a type of machine learning algorithm designed to understand human language submitted as text or sound and generate responsive text, images, sounds, or video. Many LLMs can comprise a transformer architecture capable of contextualizing words within natural language. Contextualization of natural language can occur via a process called self-attention. Self-attention allows an LLM to assign weights representing an importance of each word in a sequence relative to every other word in the sequence. In this way, an LLM can capture dependencies and relationships between words regardless of their distance from each other in the sequence of words.

A machine learning algorithm can also comprise a neural network. Generally speaking, a neural network is a type of machine learning algorithm modeled after the structure and function of the human brain. A neural network can comprise layers of interconnected neurons. Data input into a neural network can be fed into a first layer and then passed through multiple layers (e.g., hidden layers) of neurons. An output can then be generated at a final layer. Each neuron in a neural network can apply a mathematical operation to data it receives before passing an output for that neuron to a subsequent neuron. In various embodiments, connections between neurons (known as synapses) have a weight that can be adjusted during training (described below). In this way, a performance of the neural network can be optimized. In various embodiments, training a neural network can comprise adjusting weights of synapses so that the network can accurately predict vehicle attributes.

In various embodiments, a convolutional neural network (CNN) can be used. Generally speaking, a CNN is a type of neural network designed to learn how and where to identify vehicle attributes in images of a vehicle. A CNN can comprise a convolutional layer, a pooling layer, a deconvolutional layer, and/or a fully connected layer. Convolutional layers perform feature extraction using a convolution operation, pooling layers downsample feature maps to reduce a size of data in the network (and thereby increase computational efficiency), deconvolutional layers upsample feature maps to improve further improve the network's ability to learn complex features, and fully connected layers can be used to produce an output of the network. In various embodiments, a convolutional layer can implement a type of mathematical operation called a convolution that extracts vehicle attributes from inputted images of a vehicle. In various embodiments, a convolutional layer can perform convolutions on images of a vehicle taken from different angles and/or perspectives. A convolution can involve sliding a small matrix (referred to as a kernel or a filter) over images of the vehicle that have been converted into vectors and performing a dot product between the kernel and the input data. An output of a convolution can comprise a set of feature maps, each map representing a specific attribute in the input images. A feature map can be passed through an activation function (e.g., a ReLU). An output of an activation function can be passed to a next node or layer in a CNN or output as a prediction by the CNN.

In various embodiments, images of a vehicle can be fed into an LLM based computer vision system along with one or more text based prompts. All or a part of the text based prompts can be automatically constructed using an attribute identification request. A text based prompt can comprise a system message and a user message. A system message can instruct an LLM based computer vision system how to interpret instructions with images submitted for attribute identification. For example, a system message can instruct an LLM based computer vision system to act as a vehicle inspector or a vehicle technician. The system message can be repeated for each vehicle and/or attribute to ensure accuracy and prevent hallucinations. In various embodiments, a user message can instruct the LLM based machine vision system to identify specific attributes of the vehicle. In various embodiments, images of a vehicle can be ingested into the LLM based machine vision system using a function calling functionality, thereby allowing the LLM to access external data sources (e.g., images stored in a vehicle information database). In various embodiments, user prompts requesting vehicle attributes can be entered into new prompt/response interfaces for an LLM and/or progressively entered into a single prompt/response interface. The use of an LLM based computer vision system can provide for a number of technical advantages over other AI, LLM, and/or machine vision systems. Natural human language (e.g., a text prompt) can be of insufficient complexity for a computer system to determine vehicle attributes. Combining natural human language with images as an input into a machine learning algorithm allows for image understanding within a prompt. This allows a machine learning algorithm to not only extract requested information, but also identify situations where it may not have enough information within the photos (e.g., due to images cropping, incorrect staging, incorrect lighting, etc.). In embodiments where insufficient information is present, the attribute can be flagged as an error for later correction or determination of the attribute using a manual check or via other automated systems.

Similar attributes and/or attributes derived from the same or similar vehicle images can be entered into a single prompt/response interface for efficiency. Disparate attributes and/or attributes derived from images of different portions of a vehicle can be entered into a new prompt/response interface to prevent errors and/or hallucinations. In various embodiments, an LLM can output a confidence value for each attribute it identifies. In embodiments where an attribute has multiple permutations (e.g., a V8 vs a V6 engine), a list and/or a ranked list of attribute values and their associated confidence values can be chosen. Confidence values can be normalized and/or sum to a predetermined value (e.g., 1) to provide a more consistent measurement of confidence. An attribute value with a highest confidence value can be selected as a vehicle attribute for storage and/or display.

Many vehicle attributes can be identified by feeding an image of a VIN into an LLM based computer vision system. For example, a year, make, model, engine type, and/or transmission type can all be deciphered from an image of a VIN. Some LLM based machine vision systems have undesirable error rates when determining vehicle attributes based on VIN alone due to variability among manufacturers and error inherent in LLMs. For these attributes, an analysis of an image of a VIN by a LLM based machine vision system can be combined with an analysis of additional images of a vehicle. For example, for transmission type, images of an interior of a vehicle can be used. Interior images can be particularly applicable to transmission type because machine vision systems can reliably identify a third (e.g., clutch) pedal, paddle shifters behind a steering wheel, and/or a manual shifter in an approximate center of a vehicle. As another example, for drivetrain, images showing a rear portion of a vehicle can be used. Images showing a rear of a vehicle can be particularly applicable to drivetrain because machine vision systems can reliably identify and/or interpret a badge describing the drivetrain (e.g., AWD, 4WD, RWD, 2WD, FWD, 4MATIC 4WD, Quattro AWD, etc.). Rear images can also be used to determine a trim package for a vehicle in a similar manner to drivetrain. Machine vision systems can reliably identify and/or interpret a badge describing the drivetrain (e.g., LS Sedan 4D, Sport Utility 4D, GT Sport Utility 4D, Night Pickup 4D 5 ½ ft, XF 35t Prestige Sedan 4D, SL Sport Utility 4D, Standard Sedan 4D, SL Sport Utility 4D, SXT Coupe 2D, Performance Sedan 4D, etc.). Images of an interior of a vehicle can also be submitted without or in addition to images of a rear of a vehicle. In various embodiments, images of an interior of a vehicle can be used in a machine vision system to identify specific aspects of a trim package. For example, one or more of power seating, power windows, heated seating, satellite radio, power adjustable pedals, and heated mirrors can be identified by a machine vision system by submitting an image of an interior control panel or a dashboard. As a further example, leather seats can be identified by submitting an image of a passenger or rear seat.

Due to the large number of unique colors produced by vehicle manufacturers, identification of color attributes can be particularly difficult for a machine vision system. For example, what an LLM would identify as a white vehicle may actually have a color referred to as snow or eggshell. Further, many vehicle photographs are not properly white balanced and/or are taken in environments where color is altered by lighting. In various embodiments, identification of vehicle color can comprise feeding an image of a vehicle barcode (e.g., a door barcode) into a machine vision system. Many vehicle barcodes are encoded with color information from an OEM or whichever entity created the barcode. Inputting this encoded information into a computer vision system can allow the system to decode this color information, but this is not always available or decisive. For example, a barcode can be damaged or barcode identification of a color can lack detail (e.g., a color encoded as white instead of eggshell).

Many properties of vehicle paint can make it difficult for a computer vision system to differentiate between colors. For example, vehicle paint can have a layered structure and/or each layer of vehicle paint can have its own properties. Layers of vehicle paint can be applied to a vehicle base substrate (e.g., metal, fiberglass, plastic, etc.). In various embodiments, a vehicle base substrate can be electroplated to add a layer of metal and/or primer to the base substrate. Vehicle paint can comprise a primer layer that smooths out a surface of the vehicle for application of other layers. Some primer layers are tinted to accommodate compliment and/or enhance a base color layer. Vehicle paint can comprise a base color layer configured to provide a vehicle's visible color and visual appeal. A base color layer can have a number of additives. For example, metal flakes can be added to add a sparkly appearance. As another example, mica and/or ceramic particles can be added for a shimmering and/or multi tonal surface that produces a pearlescent appearance. Vehicle paint can comprise a clear coat. Clear coat can give a vehicle a glossy or matte finish. Clear coat can be an outermost surface of vehicle paint when additional layers such as sealants or ceramic coatings are not used.

One or more layers of vehicle paint can be modeled using physical based rendering (PBR) techniques. PBR is a rendering approach in computer graphics that aims to simulate the way light interacts with surfaces in the real world using physically accurate principles. PBR techniques can be used to generate a 3D shape colored with a realistic simulation of a paint color. A 3D shape can then be lit with consistent lighting across vehicles. The 3D shape can be lit using one or more image based lighting techniques. In some embodiments, light for the 3D shape can be similar or identical to light generated in a 3D scanner and/or 3D capture environment. Images of a 3D shape, the 3D shape itself, and/or maps used to create the 3D shape can be fed into a machine vision system to identify a color of a vehicle. PBR techniques can use texture maps. Texture maps can comprise a 2D image or data file used to define surface details and/or properties Maps can be used to spatially vary material properties in images of a 3D shape and/or the 3D shape itself. A number of different texture maps can be used in PBR techniques. For example, an albedo map, a metalness map, a roughness map, an ambient occlusion map, an index of refraction (IOR) map, and/or a coat map can all be used during PBR techniques.

An albedo map can comprise a measurement of a base color of a vehicle without shading, lighting, or reflections. A metalness map can comprise a measurement of the metal properties of a vehicle. For example, higher metalness can have more reflections while lower metalness can have more diffuse shading. A roughness map can comprise a measurement of how smooth or rough a surface appears. An ambient occlusion map can comprise a measurement of shadows in areas where light is blocked. A IORl map can comprise a measurement of an index of refraction, specular reflection and/or transmission (e.g., a direction and/or intensity of light reflecting off of or through a surface). A coat map can be used to simulate a coat on top of a base material. The coat map can comprise a number of different permutations and/or be divided into a number of different maps in a PBR render. For example, a coat can be simulated using one or more of a coat weight map, a coat roughness map, and/or a coat IOR map. In many embodiments, a coat weight map can control an intensity of a coat layer and/or coat map (e.g., through modulation of reflections and/or tinting). In some embodiments, a roughness map can comprise a coat roughness map. In various embodiments, an IOR map can comprise a coat IOR map.

A plurality of maps can be overlaid on one another to create a scene rendered through PBR techniques. The presence of a primer layer can affect a roughness map by making a vehicle color smoother. The presence of a base color layer can affect an albedo map by encoding itself as a base color in the albedo map. In some embodiments, a sample of an OEM provided base color can be encoded in an albedo map when creating a 3D shape. Additives to a base color layer (e.g., metal flakes and/or mica), can affect a metalness map by increasing metal properties and/or an ambient occlusion map by increasing shadows. The presence of a clear coat layer can affect an IOR map by changing a direction of reflected or transmitted light. In some embodiments, a clear coat layer can be simulated using one or more elements of a coat layer.

In various embodiments, backpropagation can be used to optimize one or more values in a PBR map. In this way, errors can be minimized between predicted outputs and actual target values for a scene rendered using PBR techniques. Backpropagation can use an error function (e.g., a loss function) to quantify a difference between predicted PBR map values and actual target values. Commonly used error functions include mean squared error for regression models and cross-entropy loss for classification models. A goal of backpropagation is to iteratively adjust weights and biases to minimize an error function. Backpropagation can comprise a backward pass. A backward pass can comprise computing a gradient of an error function with respect to a PBR map. The chain rule of calculus can be used to propagate the error gradients across the PBR map. The gradients can be successively calculated pixel by pixel.

In various embodiments, a vehicle attribute can comprise a software package installed on a vehicle. In some embodiments, a computer system can initiate an identification of a software package of a vehicle based on a VIN. For example, specific makes, models, and years of vehicles have onboard software for various purposes (e.g., self driving, enhanced features, collision avoidance, obstacle detection, etc.). When a VIN decode determines that the specific vehicle has onboard software, then identification of a software package can proceed. In some embodiments, an LLM based computer vision system can perform the VIN decode. A software package of a vehicle can be determined by feeding an image of a vehicle interface (e.g., display device 305 (FIG. 3) and/or GUI 306 (FIG. 3)) into an LLM based computer vision system. The vehicle interface can be configured to display visual and/or textual data showing a software version and/or software subscription status (e.g., expiration date, an active vs inactive subscription, etc.). For example, the interface can display a software update screen, a startup screen, an about this device screen, or any other screen displaying a software version, status, and/or presence. In some embodiments, this data can be transmitted directly to an LLM based computer vision system from a vehicle (e.g., as a screen shot) and/or as a photograph. Analysis of information displayed in an image of a vehicle interface can allow a computer system to determine specifics of a software package such as version, subscription status, subscription cost, subscription expiration date, and/or absence of software. An LLM based computer vision system can also be used to determine when errors in an image of a vehicle prevent determining all or a portion of a vehicle software package. Additional images can be requested and/or a vehicle can be flagged for further processing when errors are detected.

In various embodiments, method 100 can comprise a step 103 of updating one or more databases with a vehicle attribute. Vehicle attributes identified in preceding steps can be checked against a stored database value from an attribute. For example, a database can have a vehicle listed as a four-wheel drive vehicle while a machine vision system can identify it as having all wheel drive. In these embodiments, a database stored attribute can be updated with a newly identified attribute. Updating values in a database can involve modifying a stored datum for an attribute. An updating process ensures that a database can reflect the most current and/or accurate information while maintaining data integrity and consistency across a system. An update process can be used with various types of databases, including relational databases, NoSQL databases, and distributed database systems. In a relational database, updates are typically performed using structured query language (SQL) commands. An update command can target one or more vehicle records within a database (often stored as a table), which are identified by one or more primary keys (e.g., a VIN number or a barcode number). In NoSQL and distributed database systems, an update process can vary depending on a specific architecture and/or data model. For example, document-based databases can allow updates to nested fields within a document structure, while key-value stores update values associated with specific keys. Additionally, some systems support advanced features such as conditional updates, where modifications are applied only if specified conditions are met during execution (e.g., being supplied with a new value for a vehicle attribute). For high-performance and/or large-scale databases, batch updates can be performed to modify multiple records simultaneously. These updates are often optimized to minimize database downtime and improve update throughput.

In various embodiments, method 100 can comprise a step 104 of adding one or more annotations to one or more images of a vehicle. Attributes identified in previous steps can be added as annotations. Annotations can be used to provide supplementary information about vehicles, thereby enhancing the granularity of data that can be communicated to a user viewing images of a vehicle. Annotations can be applied to various types of vehicle data, including images, videos, text, and technical specifications. Types of annotations used can be categorized based on their purpose and/or content. Visual annotations can involve marking specific elements within images or videos to highlight relevant attributes and/or provide additional context. For example, a GUI element can be added calling out a vehicle badge that identifies a drivetrain. Interactive annotations enable users to engage with specific parts of a vehicle for a more in-depth exploration. For example, an annotation identifying a vehicle attribute can cause an image of the attribute and/or more information about the attribute to display. Text-based annotations can be used to complement images and/or videos with written information about a vehicle. For example, identified attributes can be displayed on a website as a list of vehicle features. In many embodiments, vehicle features and/or annotations can be used to identify sub and/or constituent parts of larger portions of a vehicle. For example, individual elements of a vehicle interface, dashboard, console, or engine can be identified.

In various embodiments, method 100 can comprise a step 105 of coordinating displaying at least one image of the one or more images of the vehicle. In various embodiments, an image of a vehicle can be displayed on a website. The website can comprise an interactive platform for users to browse, compare, and/or purchase vehicles. The website can comprise a homepage, a search results page, and/or a vehicle listing page. A homepage can serve as a central access point for a remainder of a website. The home page can display featured listings comprising one or more identified attributes and/or attribute annotations and search options. A navigation menu can allow users to browse vehicles by attributes such as make, model, body type, fuel type, software type, color, and many others. Advanced filtering and/or searching options can enable users to refine their search based on specific attributes. A website can comprise a search engine implementing identified attributes as metatags, thereby allowing users to input attributes to locate vehicles of interest. Search functionality can be augmented by predictive algorithms that analyze user attribute preferences and browsing history to recommend vehicles with attributes predicted to be desired by a user and show them on a search results page. Vehicle listing pages can comprise detailed attribute information about a vehicle along with images and/or videos of a vehicle. The attribute information can comprise natural language describing the attribute. In some embodiments, the natural language can comprise marketing copy featuring the attribute. The images and/or video can be annotated with the attribute information. A website can comprise a comparison tool enabling users to compare multiple vehicles side-by-side using identified attributes. The comparison tool can be used to highlight differences in specifications, features, and performance metrics via attributes. A website can comprise one or more seller tools that enable listings management. The seller tools can allow sellers to submit vehicle images for attribute identification and/or annotation as described above. Once identified and/or annotated, the images of the vehicle and any vehicle listing can be incorporated into the website.

Turning ahead in the drawings, FIG. 2 illustrates a block diagram of a system 200 that can be employed for identifying attributes, as described in greater detail below. System 200 is merely exemplary and embodiments of the system are not limited to the embodiments presented herein. System 200 can be employed in many different embodiments or examples not specifically depicted or described herein. In various embodiments, certain elements or modules of system 200 can perform various procedures, processes, and/or activities. In these or other embodiments, the procedures, processes, and/or activities can be performed by other suitable elements or modules of system 200.

Generally, therefore, system 200 can be implemented with hardware and/or software, as described herein. In various embodiments, part or all of the hardware and/or software can be conventional, while in these or other embodiments, part or all of the hardware and/or software can be customized (e.g., optimized) for implementing part or all of the functionality of system 200 described herein.

In various embodiments, system 200 can include an image capture system 210, an attribute identifying system 230, a display system 250, and/or a user computer 260. Image capture system 210, attribute identifying system 230, display system 250, and/or user computer 260 can each be a computer system, such as computer system 300 (FIG. 3), as described below, and can each be a single computer, a single server, or a cluster or collection of computers or servers, or a cloud of computers or servers. In another embodiment, a single computer system can host each of two or more of image capture system 210, attribute identifying system 230, display system 250, and/or user computer 260. Additional details regarding image capture system 210, attribute identifying system 230, display system 250, and/or user computer 260 are described herein.

In various embodiments, each of image capture system 210, attribute identifying system 230, display system 250, and user computer 260 can be a separate system, such as computer system 300 (FIG. 3). In other embodiments, or two or more of image capture system 210, attribute identifying system 230, display system 250, and user computer 260 can be combined into a single system, such as computer system 300 (FIG. 3). In any of the embodiments described in this paragraph, each separate system can be operated by a different entity or by a single entity, or two or more of each separate system can be operated by the same entity.

In various embodiments, system 200 can comprise user computer 260. In other embodiments, user computer 260 can be external to system 200. User computer 260 can comprise any of the elements described in relation to computer system 300 (FIG. 3). In various embodiments, user computer 260 can be a mobile electronic device. A mobile electronic device can refer to a portable electronic device (e.g., an electronic device easily conveyed by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For example, in various embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M 100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In various embodiments, system 200 can comprise a graphical user interface (“GUI”). In the same or different embodiments, a GUI can be part of and/or displayed by image capture system 210, attribute identifying system 230, display system 250, and/or user computer 260, and also can be part of system 200. In various embodiments, a GUI can comprise text and/or graphics (image) based user interfaces. In the same or different embodiments, a GUI can comprise a heads up display (“HUD”). When a GUI comprises a HUD, the GUI can be projected onto glass or plastic, displayed in midair as a hologram, or displayed on a display. In various embodiments, a GUI can be color, black and white, and/or greyscale. In various embodiments, a GUI can comprise an application running on a computer system, such as computer system 300 (FIG. 3), image capture system 210, attribute identifying system 230, display system 250, and/or user computer 260. In the same or different embodiments, a GUI can comprise a website accessed through internet 220. In various embodiments, a GUI can comprise an eCommerce website. In these or other embodiments, a first GUI can comprise an administrative (e.g., back end) GUI allowing an administrator to modify and/or change one or more settings in system 200 while another GUI can comprise a consumer facing (e.g., a front end) GUI. In the same or different embodiments, a GUI can be displayed as or on a virtual reality (VR) and/or augmented reality (AR) system or display. In various embodiments, an interaction with a GUI can comprise a click, a look, a selection, a grab, a view, a purchase, a bid, a swipe, a pinch, a reverse pinch, etc.

In various embodiments, image capture system 210, attribute identifying system 230, display system 250, and/or user computer 260 can be in data communication through internet 220 with each other and/or with user computer 260. In certain embodiments, as noted above, user computer 260 can be desktop computers, laptop computers, smart phones, tablet devices, and/or other endpoint devices. Image capture system 210, attribute identifying system 230, and/or display system 250 can host one or more websites. For example, display system 250 can host an eCommerce website that allows users to browse and/or search for products, to add products to an electronic shopping cart, and/or to purchase products, in addition to other suitable activities.

In various embodiments, image capture system 210, attribute identifying system 230, display system 250, and/or user computer 260 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can comprise a keyboard and/or a mouse. Further, one or more of the display device(s) can comprise a monitor and/or embedded screen. The input device(s) and the display device(s) can be coupled to the processing module(s) and/or the memory storage module(s) image capture system 210, attribute identifying system 230, display system 250, and/or user computer 260 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In various embodiments, the KVM switch also can be part of image capture system 210, attribute identifying system 230, display system 250, and/or user computer 260. In a similar manner, the processing module(s) and the memory storage module(s) can be local and/or remote to each other.

As noted above, image capture system 210, attribute identifying system 230, display system 250, and/or user computer 260 can be configured to communicate with user computer 260. In various embodiments, user computer 260 also can be referred to as customer computers. In various embodiments, image capture system 210, attribute identifying system 230, display system 250, and/or user computer 260 can communicate or interface (e.g., interact) with one or more customer computers (such as user computer 260) through a network or internet 220. Internet 220 can be an intranet that is not open to the public. In further embodiments, Internet 220 can be a mesh network of individual systems. Accordingly, In various embodiments, image capture system 210, attribute identifying system 230, and/or display system 250 (and/or the software used by such systems) can refer to a back end of system 200 operated by an operator and/or administrator of system 200, and user computer 260 (and/or the software used by such systems) can refer to a front end of system 200 used by one or more users. In these embodiments, the components of the back end of system 200 can communicate with each other on a different network than the network used for communication between the back end of system 200 and the front end of system 200. In various embodiments, the users of the front end of system 200 can also be referred to as customers, in which case, user computer 260 can be referred to as a customer computer. In these or other embodiments, the operator and/or administrator of system 200 can manage system 200, the processing module(s) of system 200, and/or the memory storage module(s) of system 200 using the input device(s) and/or display device(s) of system 200.

Meanwhile, In various embodiments, image capture system 210, attribute identifying system 230, display system 250, and/or user computer 260 also can be configured to communicate with one or more databases. The one or more databases can comprise a product database that contains information about products, items, vehicles (e.g., make, model, VIN, year, style, body type drivetrain, fuel economy, fuel type, etc.), or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 300 (FIG. 3). Also, in various embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database. Data stored in one or more databases can comprise vehicle attribute information scraped via internet 220 and/or proprietary datasets created in-house or purchased from a vendor. In various embodiments, attribute data gleaned from governmental data (e.g., NHTSA data) can be incorporated into a database.

Meanwhile, communication between image capture system 210, attribute identifying system 230, display system 250, and/or user computer 260, and/or the one or more databases can be implemented using any suitable manner of wired and/or wireless communication. Accordingly, system 200 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In various embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

Turning ahead in the drawings, FIG. 3 illustrates a block diagram of a system 300 that can be employed for identifying attributes, as described in greater detail below. System 300 is merely exemplary and embodiments of the system are not limited to the embodiments presented herein. System 300 can be employed in many different embodiments or examples not specifically depicted or described herein. In various embodiments, certain elements or modules of system 300 can perform various procedures, processes, and/or activities. In these or other embodiments, the procedures, processes, and/or activities can be performed by other suitable elements or modules of system 300.

Generally speaking, system 300 can be implemented with hardware and/or software. Part or all of the hardware and/or software implemented in system 300 can be conventional or part or all of the hardware and/or software can be customized (e.g., optimized) for implementing part or all of the functionality of system 300 described herein. When implemented as software, one or more elements of system 300 can be emulated (e.g., reproduced functionally and/or by action via software). For example, a virtual machine having one or more elements described below can be instantiated on one or more elements of system 200 (FIG. 2).

When implemented as hardware, one or more of the elements of system 300 can be coupled together using one or more chassis configured to hold one or more circuit boards and/or serial bus(es). These boards and buses allow the various elements of system 300 to communicate amongst each other to accomplish their intended purposes. While elements of system 300 are described below individually, each can also be integrated into one or more chassis, circuit boards, and/or buses of system 300. On the other hand, one or more elements of system 300 can also be removable (e.g., via a PCI slot on a motherboard and/or a USB port). One or more elements of system 300 may also be integrated and/or embedded in a different machine or manufacture. Although specific constructions of boards and buses within system 300 are not shown, it should be understood that their construction can be tied to a form factor selected for system 300.

System 300 can take a number of different form factors based on its implementation. For example, system 300 can be implemented as a desktop computer, a laptop computer, a mobile device, and/or a wearable device as described herein. Further, system 300 can comprise a single computer, a single server, a cluster or collection of computers or servers, or a cloud of computers or servers. Typically, a cluster or collection of servers can be used when the demand on 300 exceeds the reasonable capability of a single server or computer, when a distributed structure for system 300 is desired, and/or when parallel computing is desired.

In various embodiments, system 300 can comprise a processor 301, a memory storage 302, an input device 303, a graphics adapter 304, a display device 305, a graphical user interface (GUI) 306, a network adapter 307, and/or an audio output 308.

Generally speaking, processor 301 can comprise any type of computational circuit. For example, processor 301 can comprise a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, application specific integrated circuits (ASICs), etc. Processor 301 can be configured to implement (e.g., run) computer instructions (e.g., program instructions) stored on memory devices in system 300. At least a portion of the program instructions, stored on these devices, can be suitable for carrying out at least part of the functions and methods described herein. Architecture and/or design of processor 301 can be compliant with any of a variety of commercially distributed architecture families. For example, a processor can have a 32-bit (x86) architecture and/or a 64-bit (x86-64, IA64, and AMD64) architecture. Processor 301 can be configured to perform parallel computing in combination with other elements of system 300 and/or additional processors. Generally speaking, parallel computing can be seen as a technique where multiple elements of system 300 are used to perform calculations simultaneously. In this way, complex and repetitive tasks (e.g., training a predictive algorithm) can be performed faster and with less processing power than without parallel computing.

Generally speaking, memory storage 302 can comprise non-volatile memory (e.g., read only memory (ROM)) and/or volatile memory (e.g., random access memory (RAM)). The non-volatile memory can be removable and/or non-removable non-volatile memory. Meanwhile, RAM can comprise dynamic RAM (DRAM), static RAM (SRAM), or some other type of RAM. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), or some other type of ROM. Memory storage 302 can comprise non-transitory memory and/or transitory memory. All or a portion of memory storage 302 can be referred to as memory storage module(s) and/or memory storage device(s). Memory storage 302 can have a number of form factors when used in system 300. For example, memory storage 302 can comprise a magnetic disk hard drive, a solid state hard drive, a removable USB storage drive, a RAM chip, etc.

Memory storage 302 can be encoded with a wide variety of computer code configured to operate system 300. For example, portions of memory storage 302 can be encoded with a boot code sequence suitable for restoring system 300 to a functional state after a system reset. As another example, portions of memory storage 302 can comprise microcode such as a Basic Input-Output System (BIOS) operable with elements of system 300. Further, portions of the memory storage 302 can comprise an operating system (e.g., a software program that manages the hardware and software resources of a computer and/or a computer network). The BIOS can be configured to initialize and test components of system 300 and load the operating system. Meanwhile, the operating system can perform basic tasks such as, for example, controlling and allocating memory, prioritizing the processing of instructions, controlling input and output devices, facilitating networking, and/or managing files. Exemplary operating systems can comprise software within the Microsoft® Windows®, Mac OS®, Apple® iOS®, Google® Android®, UNIX®, and/or Linux® series of operating systems.

Input device 303 can be configured to allow a user to interact and/or control elements of system 300. A number of devices can be used as input device 303 alone or in combination. For example, input device 303 can comprise a keyboard, a mouse, a touch screen, a microphone, a camera, etc. Input device 303 can be coupled to other elements of system 300 in a number of ways. For example, input device 303 can be coupled via a Universal Serial Bus (USB) port in a wired and/or wireless manner or via a specialized port (e.g., a PS/2 port) depending on the specific device. User inputs through input device 303 can come in a number of forms. For example, when input device 303 comprises a microphone, user input can be received via voice commands and/or a speech to text algorithm. As another example, when input device 303 comprises a camera, user input can be received via bodily movements that are captured and interpreted by system 300.

Generally speaking, graphics adapter 304 can be configured to receive and/or generate one or more elements for display on display device 305. Exemplary embodiments of graphics adapter 304 can comprise devices within the NVIDIA® GeForce® and/or the AMD® RX® series of video cards. In various embodiments, a chipset present on graphics adapter 304 can be configured to perform similar, simultaneous computations in a manner more efficient than other chipsets. For example, rendering a 3D scene on graphics adapter 304 can involve repeated geometric calculations performed in parallel to generate the 3D scene. As another example, repeated mathematical calculations involved in training a predictive algorithm can be performed in parallel on graphics adapter 304 more efficiently than on processor 301. Display device 305 can receive and display signals from graphics adapter 304. A number of devices can be used as display device 305. For example, display device 305 can comprise a computer monitor, a television, a touch screen display, a heads up display (HUD) medium, etc.

In various embodiments, display device 305 can optionally display graphical user interface (GUI) 306. GUI 306 can be a part of and/or displayed by one or more web devices 202-203 (FIG. 2). GUI 306 (or elements thereof) can also be stored 3D display system 250 and/or user computer 260. With regards to form, GUI 306 can comprise text and/or graphics (image) based user interfaces. For example, GUI 306 can comprise GUI 500 (FIG. 5)). As another example, GUI 306 can comprise a heads up display (HUD). When GUI 306 comprises a HUD, GUI 306 can be projected onto a medium (e.g., glass, plastic, metal, etc.), displayed in midair as a hologram, and/or displayed on display device 305. GUI 306 can be color, black and white, and/or greyscale. GUI 306 can be implemented as an application running on a computer system, such as 3D display system 250 and/or user computer 260. GUI 306 can also comprise a website accessed through a network (e.g., internet 220 (FIG. 2)). For example, GUI 306 can comprise a website or installed software application. When GUI 306 allows for modification and/or changes to one or more settings in system 300, it can be referred to as an administrative (e.g., back end) GUI. GUI 306 can also be displayed as or on a virtual reality (VR) and/or augmented reality (AR) system or display. GUI 306 can receive a number of interactions from a user via input device 303. For example, an interaction with a GUI can comprise a click, a look, a selection, a grab, a view, a purchase, a bid, a swipe, a pinch, a reverse pinch, etc.

Network adapter 307 can be configured to connect system 300 to a computer network by wired communication (e.g., a wired network adapter) and/or wireless communication (e.g., a wireless network adapter). Network adapter 307 can be integrated into one or more chassis, circuit boards, and/or buses or be removable (e.g., via a PCI slot on a motherboard). For example, network adapter 307 can be implemented via one or more dedicated communication chips configured to receive various protocols of wired and/or wireless communications. Audio output 308 can be configured to receive and/or generate one or more audio signals for play through a speaker and/or microphone. Exemplary audio outputs can comprise an audio card.

Camera 309 can comprise a variety of internal and external cameras capable of capturing digital images. For example, camera 309 can comprise a digital single-lens reflex (DSLR) camera, a mirrorless camera, a point-and-shoot camera, a video camera, a bridge camera, an action camera, a 360-degree camera, a medium format camera, a smartphone camera, a drone camera, etc. Camera 309 can communicate with additional elements of system 300 via wired and/or wirelessly communication. When wired, camera 309 can be integrated into system 300 (e.g., a smartphone camera) or coupled via one or more removable cables. Camera 309 can comprise one or more removable storage mediums capable of transferring stored photographs for transfer to other systems.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, In various embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, In various embodiments, the time delay can be less than approximately one second, two seconds, five seconds, or ten seconds.

As defined herein, “approximately” can, In various embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although systems and methods for automatic identification of vehicle attributes have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-3 may be modified, and that the foregoing discussion of certain of these embodiments does not necessarily represent a complete description of all possible embodiments. For example, one or more of the procedures, processes, or activities of FIG. 1 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory memories storing computing instructions configured to communicate with the one or more processors and cause the one or more processors to perform:
identifying one or more attributes of a vehicle using a machine vision system based on at least one of a vehicle identifier, an array of one or more vehicle attributes, or an array of one or more images of the vehicle;
adding one or more annotations to the one or more images of the vehicle based on the one or more attributes of the vehicle; and
coordinating displaying at least one image of the one or more images of the vehicle, as annotated.

2. The system of claim 1, wherein the one or more vehicle attributes comprise one or more of a year of the vehicle, a make of the vehicle, a model of the vehicle, an engine type of the vehicle, and a transmission type of the vehicle and wherein the identifying the one or more attributes comprises inputting an image of a vehicle identification number of the vehicle into the machine vision system.

3. The system of claim 1, wherein the one or more vehicle attributes comprise one or more of a trim package of the vehicle, and wherein the identifying the one or more attributes comprises inputting a backside image of the vehicle into the machine vision system.

4. The system of claim 1, wherein the one or more vehicle attributes comprise a color of the vehicle, and wherein the identifying the one or more attributes comprises inputting one or more physical based rendering characteristics of automobile paint into the machine vision system.

5. The system of claim 4, wherein the one or more physical based rendering characteristics of the automobile paint comprise a metalness map modeling mica particles in the automobile paint.

6. The system of claim 1, wherein the one or more vehicle attributes comprise a software package of the vehicle, and wherein the identifying the one or more attributes comprises inputting an image of a vehicle interface of the vehicle into the machine vision system.

7. The system of claim 6, wherein identifying the one or more attributes comprises identifying the vehicle as having at least partially autonomous functionality.

8. A method comprising:
identifying one or more attributes of a vehicle using a machine vision system based on at least one of a vehicle identifier, an array of one or more vehicle attributes, or an array of one or more images of the vehicle;
adding one or more annotations to the one or more images of the vehicle based on the one or more attributes of the vehicle; and
coordinating displaying at least one image of the one or more images of the vehicle, as annotated.

9. The method of claim 8, wherein the one or more vehicle attributes comprise one or more of a year of the vehicle, a make of the vehicle, a model of the vehicle, an engine type of the vehicle, and a transmission type of the vehicle and wherein the identifying the one or more attributes comprises inputting an image of a vehicle identification number of the vehicle into the machine vision system.

10. The method of claim 8, wherein the one or more vehicle attributes comprise one or more of a trim package of the vehicle, and wherein the identifying the one or more attributes comprises inputting a backside image of the vehicle into the machine vision system.

11. The method of claim 8, wherein the one or more vehicle attributes comprise a color of the vehicle, and wherein the identifying the one or more attributes comprises inputting one or more physical based rendering characteristics of automobile paint into the machine vision system.

12. The method of claim 11, wherein the one or more physical based rendering characteristics of the automobile paint comprise a metalness map modeling mica particles in the automobile paint.

13. The method of claim 8, wherein the one or more vehicle attributes comprise a software package of the vehicle and identifying the one or more attributes comprises inputting an image of a vehicle interface of the vehicle into the machine vision system.

14. The method of claim 13, wherein identifying the one or more attributes comprises identifying the vehicle as having at least partially autonomous functionality.

15. One or more articles of manufacture including one or more non-transitory, tangible computer readable storage mediums having instructions stored thereon that, in response to execution by one or more processors, cause the one or more processors to perform:
identifying one or more attributes of a vehicle using a machine vision system based on at least one of a vehicle identifier, an array of one or more vehicle attributes, or an array of one or more images of the vehicle;
adding one or more annotations to the one or more images of the vehicle based on the one or more attributes of the vehicle; and
coordinating displaying at least one image of the one or more images of the vehicle, as annotated.

16. The one or more articles of manufacture of claim 15, wherein the one or more vehicle attributes comprise one or more of a year of the vehicle, a make of the vehicle, a model of the vehicle, an engine type of the vehicle, and a transmission type of the vehicle and wherein the identifying the one or more attributes comprises inputting an image of a vehicle identification number of the vehicle into the machine vision system.

17. The one or more articles of manufacture of claim 15, wherein the one or more vehicle attributes comprise one or more of a trim package of the vehicle, and wherein the identifying the one or more attributes comprises inputting a backside image of the vehicle into the machine vision system.

18. The one or more articles of manufacture of claim 15, wherein the one or more vehicle attributes comprise a color of the vehicle, and wherein the identifying the one or more attributes comprises inputting one or more physical based rendering characteristics of automobile paint into the machine vision system.

19. The one or more articles of manufacture of claim 18, wherein the one or more physical based rendering characteristics of the automobile paint comprise a metalness map modeling mica particles in the automobile paint.

20. The one or more articles of manufacture of claim 15, wherein the one or more vehicle attributes comprise a software package of the vehicle, and wherein the identifying the one or more attributes comprises inputting an image of a vehicle interface of the vehicle into the machine vision system.
